(19) United States
(12) Patent Application Publication
(10) Pub. No.: US 2015/0090129 A1
(43) Pub. Date: Apr. 2, 2015

(54) BATTERY-POWERED ADJUSTABLE REVOLVING SKEWER

(71) Applicant: Luciano Kaefer ME, Porto Alegre (BR)

(72) Inventor: Luciano KAEFER, Porto Alegre - RS (BR)

(73) Assignee: Luciano Kaefer ME, Porto Alegre (BR)

(21) Appl. No.: 14/040,623

(22) Filed: Sep. 28, 2013

(51) Int. Cl. A47J 37/04

(52) U.S. Cl. CPC A47J 37/049
USPC 99/421 R

(57) ABSTRACT

A battery-powered adjustable revolving skewer to be used in built barbecue pits as in any other arrangement in which is allowed to put a heat source (embers) and two supports to sustain the ends of the battery-powered adjustable revolving skewer.

### INVENTION FIELD

This utility model refers to a battery-powered adjustable revolving skewer to be used in built barbecue pits as in any other arrangement in which is allowed to put a heat source (embers) and two supports to sustain the ends of the battery-powered adjustable revolving skewer.

### DESCRIPTION OF RELATED ART

It is fully aware by society the search for new techniques and facilities that allow roasting beef in ideal temperature for consumption accordingly to individual preferences.

Basically, all existing models are alike in some aspects, but the details of this utility model will offer greater functionality to the user, standing out from the other existing utility models.

The common base to all existing models consists of a reservoir to place either coal or firewood, and more above, two support points to place the skewer that, having been the beef skewered and tempered, it is baked by heat exposure generated by embers.

In traditional roasts it is needed a great expertise of the roaster, in order to maintain equally baked both sides of the meat to prevent that one side becomes more cooked. It demands a high level of knowledge and techniques that, with use of revolving barbecue pits, the roaster will have your job minimized.

However, the barbecue pits use electrical power to trigger an engine and a pre-existing construction supported by a mechanical/electrical device that makes the work to turn the meat to provide the roast.

In order to fulfill this need, utility models were built that discharge the structure set up of the electrical revolving barbecue pit using small engines in their cables to make the skewers to turn around its own axis using the engine as source of strength.

This utility model, although has been partially succeed to solve the process, it has a limitation due to the need of existing electrical power and electricity network, making the use impossible in locals where electrical power fails. There is also another limitation for those who use an engine with 110 Volts tension as they are limited to take this model to another location with different electrical tension, the same applying to 220 Volts engines.

Another utility model created uses rechargeable batteries as power source and equally has technical limitations, because as of public knowledge, rechargeable batteries lose part of charge capacity with use, making skewer obsolete in a short time due to the exhaustion of charge capacity offered.

Moreover, batteries used in this utility model are not easily found in the market, which forces manufacturer to change the set of batteries in the skewer shipping, taking time and becoming uncomfortable for the user.

Another undesirable point in the utility model is its incapacity of adapting to various sizes of barbecue pits, because it cannot be adjusted, so consumer relies on the chosen size by the inventor of the referred utility model.

### SUMMARY OF THE INVENTION

The proposed utility model has a difference for the use of common alkaline batteries or even rechargeable, being batteries size namely AA models found easily in any business premises, which allows its use in any place or circumstance, enabling users to take the battery-powered adjustable revolving skewer anywhere, regardless of the existence of electrical power in the location.

Tests made have proved that the referred utility model battery-powered adjustable revolving skewer has 20-hour autonomy using 4 common batteries and 60 hours using 4 alkaline batteries, working with 6 kg load weight.

Inside de battery compartment is offered a clip to turn on the 9V battery in case the user wants the engine to turn in a higher rotation. This 9 Volts battery is the same as the easily found in any business premises, and can be common, alkaline or rechargeable.

It is foreseen in the project for this utility model battery-powered adjustable revolving skewer placing a special input for a solar power supply, making the battery-powered adjustable revolving skewer an alternative for the environmental pollution.

### BRIEF DESCRIPTION OF THE DRAWINGS

FIG. 1/1 shows a perspective view of the the battery-powered adjustable revolving skewer of the instant disclosure.

### DETAILED DESCRIPTION OF THE PREFERRED EMBODIMENTS

For a clear insight into its functioning, there are illustrative drawings of this utility model in order to better elucidate the following description:

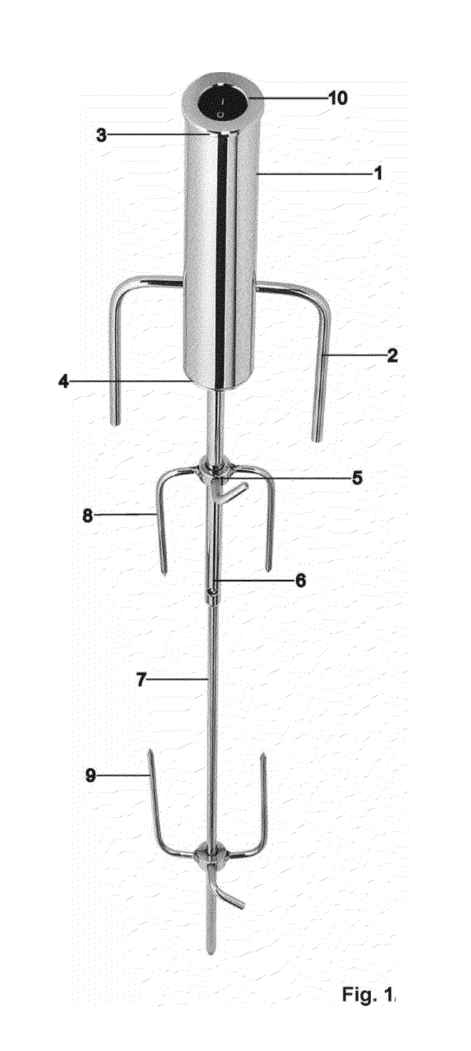

FIG. 1/1—represents the total view of the battery-powered adjustable revolving skewer.

According to the view, FIG. 1 represents the stainless steel cable that will accommodate the engine at 1.5 RPM, the battery compartment and the back (3) and front (4) covers in which back cover (1) is shown in perspective in the FIG. 10) houses the on-off switch that will trigger the electrical system inside the cable (1).

The skewer supporting stick (2) serves to prevent the skewer to turn around its own axis while working. The projection in a few centimeters forward makes the engine to get distance from the heat source, protecting the system.

The front cover (4) supports the weight of up to 6 kg of meat.

The fixation screw (5) serves to lock the skewer after being adjusted its size that can vary from 50 to 70 cm.

This screw for fixation in the expandable skewer passes through one of the three holes open in the adjustment tube (6).

The stainless steel 304 expandable skewer (7) (suitable for food use) has 50 cm and it is introduced through the adjustment tube (6).

The short upper clutch (8) after being adjusted its size in the barbecue pit serves as fixation for the meat, exactly as the short lower clutch (9), so that the meat does not turn around its own axis.

While triggering the on-off switch (10), there is a power transmission that comes from common batteries, transmitting strength to the engine shaft which, in turn, will move the adjustment tube (6).

Being the battery-powered adjustable revolving skewer adjusted to the barbecue pit size and being introduced the meat to be roasted, and the short upper (8) and lower (9) clutches properly locked by the fixation screw (5), initiating the meat cooking.

The cable distance (1) through the supporting stick (2) prevents the heat to damage the engine and the batteries as there will be less heat in the cable (1).

The clutches (FIGS. 8 and 9) support any type of meat (chicken, fish and beef) until 6 kg limit.

The back cover is easily removed as there is within a rubber ring with enough pressure to open or close the cable (1), having access to the 4-battery compartment.

As rechargeable batteries are not used, the consumer will have the peace of mind of purchasing your batteries anywhere, because they are easily found.

It has adjustment from 50 to 70 cm due to the adjustment tube (6) which gives the battery-powered adjustable revolving skewer the possibility of taking it anywhere, unlike other utility models that use electrical power to move the engines.

The battery-powered adjustable revolving skewer appearance (1/1) also stands out as, at the moment of roasting the meat, all wires offered by the other utility models disappear.

Also, the battery-powered adjustable revolving skewer has a cable extremely anatomic (38 mm externally), exactly the same size of the business skewers, making it look like a common skewer more pleasant to the environment.

1. A battery-powered adjustable revolving skewer consisting of a cable (1) that houses the engine, the battery compartment and the back cover (3) that has an on-off switch (10) and supports the adjustment tube, which in turn houses the expandable skewer (7), being this last one (expandable skewer, FIG. 7) supports the meat weight, being locked with use of short upper clutches (8) and short lower clutches (9).

2. A battery-powered adjustable revolving skewer according to claim 1, characterized by having battery compartment easily found in the market.

3. A battery-powered adjustable revolving skewer according to claim 1, characterized by having size adjustment, not existing in models of similar utility.
